(19) United States
(12) Patent Application Publication
(10) Pub. No.: US 2004/0062036 A1
(43) Pub. Date: Apr. 1, 2004

(54) Light pen with the functions of illumination and logo indication

(76) Inventor: Kevin Ching-Yi Kuo, Taipei County (TW)

Correspondence Address: Kevin Ching-Yi Kuo, P.O. Box No. 6-57, Chung-Ho, Taipei, 235, TW

(21) Appl. No.: 10/255,593

(22) Filed: Sep. 27, 2002

(51) Int. Cl. B43K 29/10

(52) U.S. Cl. 362/118; 362/205; 362/800

(57) ABSTRACT

The present invention relates to a pen structure, more particularly, a pen with the functions of illumination and logo indication, which comprises a main body and an illuminant, wherein the lower portion of the main body is a pen instrument for writing and the upper portion is a housing member with a lateral aperture. The inner surface of the housing member is reflective. The illuminant consists of a transparent barrel, a LED, a push-button switch, a plurality of batteries and a tail cap. The functions of illumination and logo indication can be served respectively by the interactive reflection of the inner surface while placing the illuminant from different ends thereof in the housing member.

### BACKGROUND OF THE INVENTION

1. Field of the Invention

The present invention relates to a light pen structure, more particularly, a light pen with the functions of illumination and logo indication, which consists of a main body and an illuminant. By inserting the illuminant from different ends thereof in a housing member of the main body can it provide illumination at different segments whereby the functions of illumination and log indication are served respectively.

2. Description of the Prior Art

Conventionally, a pen is simply a writing instrument. However, people nowadays have higher requirement in the functions of items. Therefore, in order to make the use of pens multifunctional, inventors have designed different pen structures, one of which is the “light pen”. However, the main structure of the generally commercial light pens is to add a light source and a switch in the upper barrel of the pen, and provide illumination by turning on/off the light source via the switch. Others using a transparent lower barrel wherein the light source is hided, and by turning on/off the switch can the light flash on as decoration. Although the above light pen structures have given conventional pens a new function, in the changing days, the simply added illumination or decoration seems not to be able to fulfill people's need.

For this reason, according to the inventor's experiences and knowledge in manufacturing and trading in the pen industry, a light pen with the functions of illumination and logo indication is finally invented after continuously studying and improving. The light pen consists of a main body and an illuminant. The lower portion of the main body is a pen instrument for writing, and the upper portion is a housing member with a lateral aperture thereof. The inner surface of the housing member is reflective. The illuminant comprises a transparent barrel, a LED, a push-button switch, a plurality of batteries and a tail cap. The illuminant can be inserted forwards or backwards into the housing member wherein the reflection of the inner surface projects the light at different segments when the illuminant is planted from different ends thereof, and thereby the functions of illumination and logo indication can be performed.

### SUMMARY OF THE INVENTION

The primary objective of the present invention is to provide a light pen with both added functions of illumination and logo indication, which can be achieved when lights are emitted from different segments of the illuminant because of the insertion of the illuminant from different ends thereof into the housing member and the reflection of the housing member inner surface.

Another objective of the present invention is to provide a light pen with both illumination and logo indication, wherein the illuminant can be operated by simply depressing the push-button switch and outside the housing member.

To enable a further understanding of the objectives as well as other objectives and structure details of the invention herein, the detailed description of the invention herein along with the brief description of the drawings below shall provide additional elaboration.

### BRIEF DESCRIPTION OF THE DRAWINGS

FIG. 1 is an isometric exploded view of the present invention.

FIG. 2 is a perspective view of the illuminant structure of the present invention.

FIG. 3 is a perspective view of the present invention as for illumination.

FIG. 4 is a perspective view of the present invention as for logo indication.

### DESCRIPTION OF THE PREFERRED EMBODIMENTS

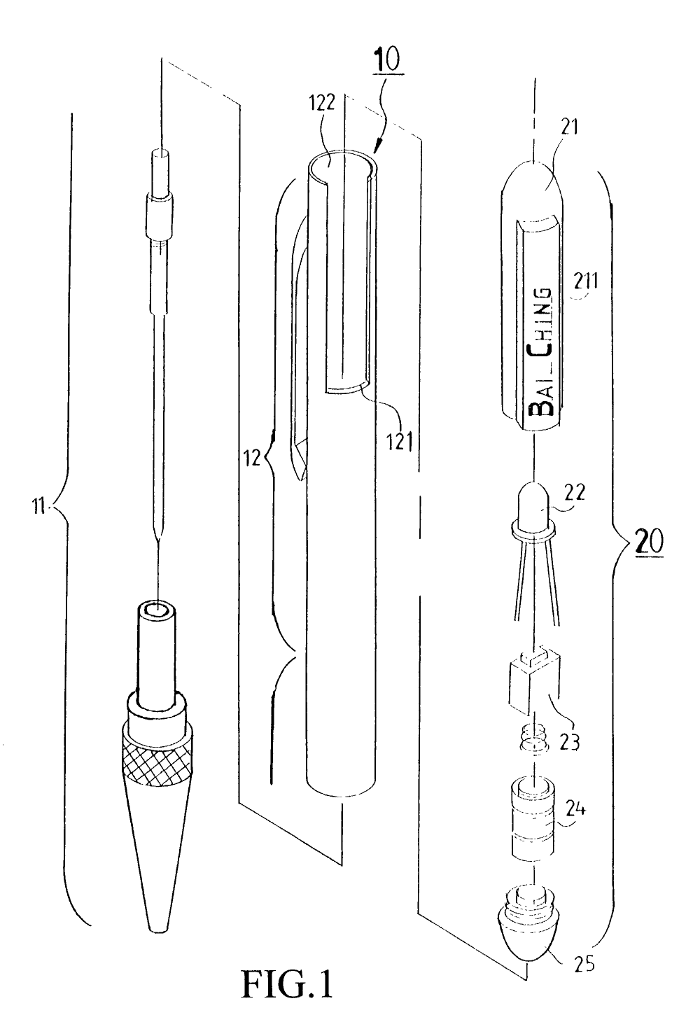

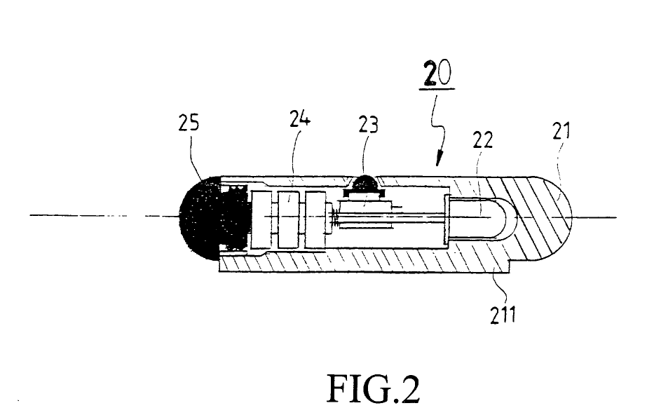

First, please referring to FIG. 1 and FIG. 2, the present invention of a light pen with the functions of illumination and logo indication includes a main body 10 and an illuminant 20, wherein: the main body 10, consisting a lower portion 11 whereof a pen instrument for writing, and an upper portion 12 whereof a housing member 122 with a lateral aperture 121 which allows the insertion of the illuminant 20 and is reflective on the inner surface.

The illuminant 20 which can be inserted forwards or backwards into the housing member 122 of the main body 10 consists of a transparent barrel 21, a LED 22, a push-button switch 23, a plurality of batteries 24 and a tail cap 25, wherein the surrounding of the transparent barrel 21 has a bulge 211 therein to mount the lateral aperture 121 of the housing member 122 in the main body 10.

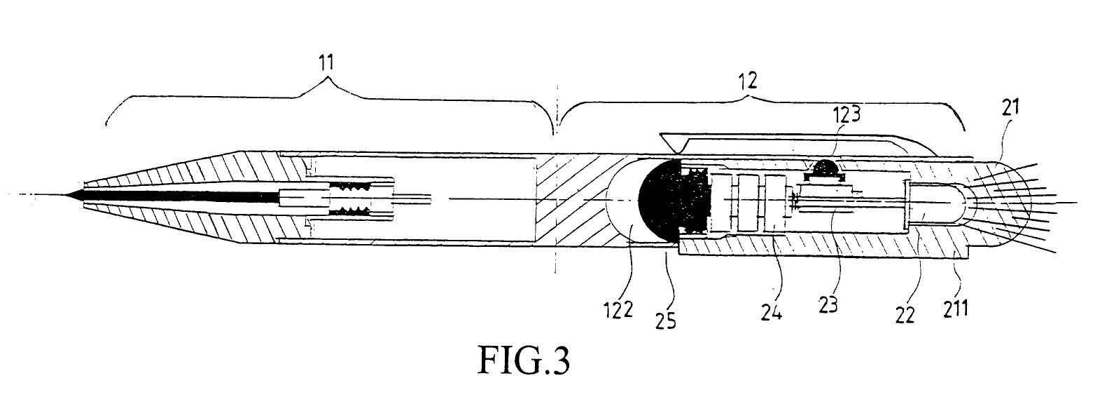

As for the illumination, referring to FIG. 3, the illuminant 20 is inserted from the tail cap 25 end into the housing member 122 of the main body 10, wherein the outer surrounding bulge 211 on the transparent barrel 21 of the illuminant 20 is fit to the lateral aperture 121 of the housing member 122, and then pushed to the bottom. By which the push-button switch 23 of the illuminant 20 is able to rise from the hole 123 opposite to the lateral aperture 121 of the housing member 122, which turns off the LED 22 of the illuminant 20. To turn on the illuminant, simply slide the bulge 211 on the outer surface the transparent barrel 21 which enables the push-button switch 23 of the illuminant 20 to be released from the hole 123 and turned on by being depressed. Of course, the illuminant 20 can be turned on by depressing the push-button switch 23 directly by hand without being inserted into the housing member 122.

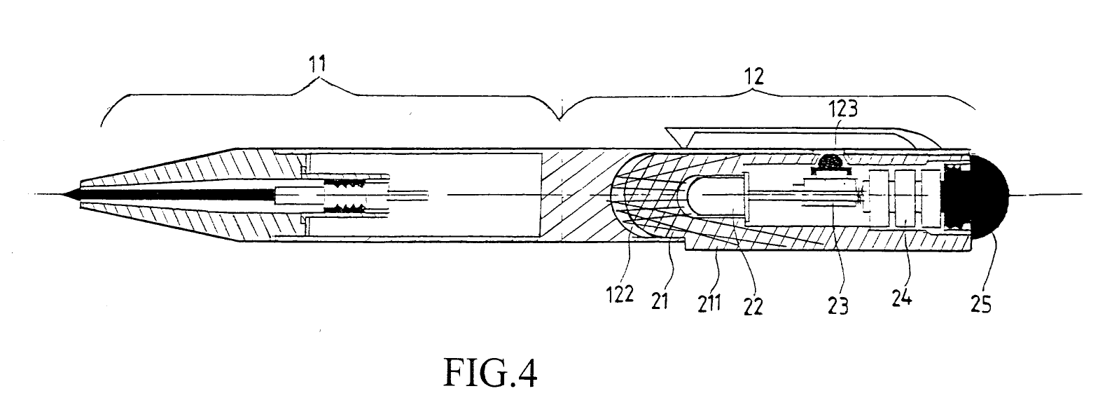

As for the logo indication, referring to FIG. 4, the illuminant 20 is inserted from the LED 22 end thereof into the housing member 122 of the main body 10, fitting the outer surface bulge 211 on the transparent barrel 21 of the illuminant 20 to the lateral aperture 121 of the housing member 122 and then pushed to the bottom. By sliding the external bulge 211 on the transparent barrel 21 can the push-button switch 23 of the illuminant 20 be depressed, which enables the LED 22 to emit lights, and by the reflection on the inner surface of the housing member 122, lights are projected to the transparent barrel 21. Since the transparent barrel 21 of the illuminant 20 is mounted inside the upper portion 12 of the main body 10 and only the external bulge 211 of transparent barrel 21 is exposed, the external bulge 211 thus emits lights whereby the logo is highlighted, especially in the dark.

In summation of the forgoing section, the present invention of a light pen with both illumination and logo indication functions is a breakthrough to the single added function design of the commercial light pens, and gives light pens multifunctional usage. Since the invention is practical and progressive, it matches the key elements for the patent application. Therefore, the inventor submits this patent application according to the law. It would be appreciated if the examiners can examine the application in detail and authorize the deserving patent promptly.

1. A light pen with the functions of illumination and logo indication comprises a main body and a illuminant, wherein:
the said main body has a lower portion thereof which is a pen instrument for writing, and a upper portion thereof which is a housing member with a lateral aperture wherein the illuminant is inserted and the inner surface is reflective; the said illuminant which can be inserted forwards and backwards in the housing member of the said main body consists of a transparent barrel, a LED, a push-button switch, a plurality of batteries and a tail cap, wherein the external bulge of the transparent barrel can be mounted to the lateral aperture of the housing member of the main body; with the above compartments, the illuminated segment of the illuminant differs when inserting the illuminant from different ends, which leads to the different functions of illumination and logo indication.

2. The light pen with the functions of illumination and logo indication in accordance with claim 1, wherein the illuminant can provide illumination by depressing the switch by hand without being inserted into the housing member.
